(19) United States
(12) Patent Application Publication
(10) Pub. No.: US 2007/0273924 A1
(43) Pub. Date: Nov. 29, 2007

(54) RECORDING MEDIUM STORING PRINTING PROGRAM, PRINTING APPARATUS, PRINTING METHOD, AND COMPUTER DATA SIGNAL EMBODIED IN CARRIER WAVE

(75) Inventor: Kazuaki OZAWA, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: Fuji Xerox Co., Ltd., Tokyo (JP)

(21) Appl. No.: 11/753,597

(22) Filed: May 25, 2007

(30) Foreign Application Priority Data
May 26, 2006 (JP) 2006-147143
Apr. 24, 2007 (JP) 2007-114308

(51) Int. Cl. G06F 3/12

(52) U.S. Cl. 358/1.15

(57) ABSTRACT

A computer readable recording medium storing a printing program for causing a computer included in a printing apparatus having a printing out section to execute a process, the process which includes storing apparatus information about the printing apparatus; generating a job execution ticket including the stored apparatus information on receiving a printing request from an external apparatus; sending the generated job execution ticket to the external apparatus; receiving from the external apparatus printing job in which a job execution ticket is embedded; determining whether apparatus information about printing apparatus included in the job execution ticket embedded in the received printing job is identical to the stored apparatus information; and sending to the printing out section, when the apparatus information are determined to be identical, the printing job in which the job execution ticket is embedded.

### BACKGROUND

1. Technical Field

The present invention relates to a recording medium storing printing program, a printing apparatus, a printing method, and a computer data signal embodied in a carrier wave.

2. Related Art

Recently, with the increasing demand for the information security to prevent information leakage or illegal use, monitoring communication data, inspection of processing contents and other measures have been carried out regularly or in a resident manner. Leakage or illegal use of the confidential information and the like might lead to loss of confidence in companies or individuals, and result in unintended consequences.

Under such circumstances, in a printing system made up of a client computer, a printer server, a printer and other devices, the printer that prints out electronic documents protects and internally controls the confidential information by using such value-added functions as obtainment of logs of each printing (logging), inspection of printing content and on-demand printing in which printing out is performed based on the instruction from a user as necessary.

Especially, from the viewpoint of prevention of illegal use, the printer has a function of determining whether printing out is performed or not by setting the criteria, in advance, for judging whether specific user or device is allowed or not allowed to carry out the printing process, then by identifying a requester at the time of printing request, and by matching the requester with the set criteria.

### SUMMARY

According to an aspect of the invention, there is provided a computer readable recording medium storing a printing program for causing a computer included in a printing apparatus having a printing out section to execute a process, the process which includes storing apparatus information about the printing apparatus; generating a job execution ticket including the stored apparatus information on receiving a printing request from an external apparatus; sending the generated job execution ticket to the external apparatus; receiving from the external apparatus printing job in which a job execution ticket is embedded; determining whether apparatus information about printing apparatus included in the job execution ticket embedded in the received printing job is identical to the stored apparatus information; and sending to the printing out section, when the apparatus information are determined to be identical, the printing job in which the job execution ticket is embedded.

### BRIEF DESCRIPTION OF THE DRAWINGS

Exemplary embodiments of the present invention will be described in detail based on the following figures, wherein:

FIG. 1 is one example of a system configuration drawing of a printing system configured by applying the printing program and the printing apparatus pertaining to the exemplary embodiment of the present invention;

FIG. 2 is one example of a block diagram illustrating the detailed configuration of a print server constituting the printing system as shown in FIG. 1;

FIG. 3 is one example of a block diagram illustrating the detailed configuration of a printer constituting the printing system as shown in FIG. 1;

FIG. 4A to FIG. 4D are drawings illustrating one example of a printing job generated by the printing job generation section of the print server as shown in FIG. 2;

FIG. 5 is one example of a sequence diagram illustrating the status transition of the printing system configured by applying the printing program pertaining to the exemplary embodiment of the present invention;

FIG. 6 is a drawing illustrating a logical structure of the printing system configured by applying the printing program pertaining to the exemplary embodiment of the present invention;

FIG. 7 is one example of a sequence diagram illustrating the status transition of the printing system configured by applying the printing program pertaining to the exemplary embodiment of the present invention;

FIG. 8 is one example of a detailed flowchart illustrating the flow of generation processing for generating a job execution ticket;

FIG. 9 is one example of a detailed flowchart illustrating the flow of checking processing for checking the job execution ticket;

FIG. 10A to FIG. 10D illustrate the printing job to which the job execution ticket in Second Example is assigned;

FIG. 11 is one example of a flowchart illustrating the flow of the processing for generating a printing job in the print server;

FIG. 12 is one example of a flowchart illustrating the flow of checking processing of a job execution ticket in the printer;

FIG. 13A to FIG. 13D are conceptual drawings illustrating the outline of Third Example;

FIG. 14 is one example of flowchart illustrating the flow of processing for generating a printing job in the print server; and

FIG. 15 is one example of flowchart illustrating the flow of checking processing of a job execution ticket in the printer.

### DETAILED DESCRIPTION

Hereinbelow, one example of a recording medium storing printing program, a printing apparatus, a printing method, and a computer data signal embodied in a carrier wave pertaining to an exemplary embodiment of the present invention will be described in detail with reference to the attached drawings.

### FIRST EXAMPLE

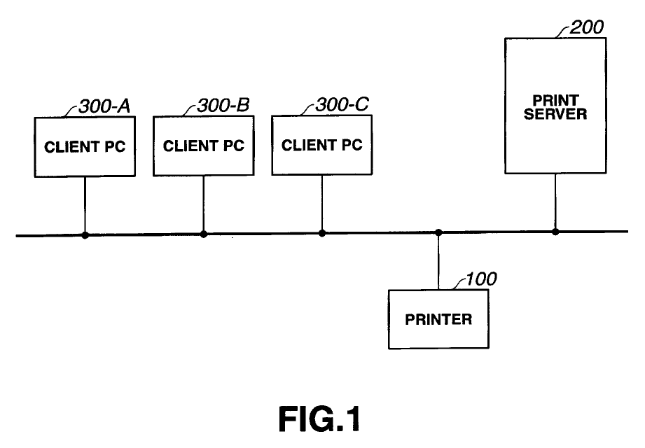

FIG. 1 shows one example of system configuration drawing for a printing system including the printing program and the printing apparatus pertaining to the exemplary embodiment of the present invention.

In FIG. 1, the printing system includes a printer 100, which is a printing apparatus, a print server 200, and a client PC (300-A, 300-B, 300-C) (hereinafter collectively referred to as “client PC 300”). The printer 100 carries out printing processing on the basis of a printing request from the print server 200 that has a permission to print and the client PC 300. This printing system may be configured to include plural printers 100.

In the client PC 300, various applications for carrying out document generation and computation processing are installed. By carrying out a printing operation on the electronic document or image data generated by using such applications, printing data to be printed out is generated and sent to the print server 200 as the destination. At this time, if printing request is directed to the printer 100 instead of the print server 200 as the destination, a “printing rejection response” will be given as a reply from the printer 100, and printing out by the printer 100 is rejected.

The printing rejection response given as a reply from the printer 100 includes address information on the print server 200 to be assigned as the destination at the time of printing request, and the client PC 300 that received this printing rejection response changes the destination on the basis of the address information on the print server 200, and again carries out the printing request processing.

The print server 200 temporarily accumulates the printing data for the printing request received from the client PC 300; carries out printing control, such as logging, data checking, or the like; and notifies the printer 100 of request for printing (hereinafter, a “printing execution verification notification”). At this time, the printer 100 that is the destination of this printing execution verification notification is registered in the print server 200 in advance.

When there exist plural printers 100 on the network, the printing system may be configured such that, after an optimum printer that satisfies the printing conditions is searched, the printing execution verification notification is transferred to that printer.

This print server 200 receives a job execution ticket showing that printing permission is given as a response from the printer 100 to the printing execution verification notification that the printer server 200 sends. After receiving the job execution ticket, the print server 200 embeds the received job execution ticket in the temporarily accumulated printing data, and requests the printer 100 that issues the job execution ticket to print as a printing job.

This job execution ticket is a ticket that the printer issues to an external apparatus (for example, the print server 200) for permitting to print, and includes pieces of information, such as the address information on the print server 200 that is permitted to print, the address information on the printer 100, the time when the ticket is issued (the time of generation of the ticket), and the like.

As examples for the address information, the MAC (Media Access Control) address, which is the physical address of each of the apparatuses, the IP address, the apparatus name, and the like may be used. However, in the following description, an example will be described in the case where the MAC address is used as the address information.

When the job execution ticket is issued by the printer 100 in the encrypted state, the job execution ticket is embedded in printing data in the encrypted state, and a printing job is generated.

The printer 100 prints out the printing data for the printing job for which printing is requested. In addition, when receiving the printing execution verification notification from the print server 200, the printer 100 analyzes printing requester's MAC address that is included in that printing execution verification notification and generates a job execution ticket that includes the MAC address set for the printer 100 and the time when the generation is made.

The generated job execution ticket is encrypted using the encryption algorithm that is previously assigned. At this time, the encrypted job execution ticket may be provided with a checking code, such as a CRC (Cyclic Redundancy Check) code, or the like, and be transferred to the print server 200. In this case, the job execution ticket embedded in the printing data in the print server 200 is provided with the checking code, thus the job execution ticket also becomes a state where the checking code is embedded.

And, the printer 100 sends the generated job execution ticket to the print server 200 from which the printing execution verification notification is received.

This printer 100 verifies whether the job execution ticket is embedded in the printing job by carrying out reading processing, and prints out that printing job for which printing is requested by the print server 200.

When the job execution ticket cannot be verified because the job execution ticket cannot be read, no job execution ticket is embedded in the printing data for the printing job, or the like, the printer 100 replies to the print server 200, which is the printing requester, that it cannot carry out the printing out.

On the other hand, when it is verified that the job execution ticket is embedded in the printing job, the job execution ticket is then decrypted. It is verified that the ticket issuer MAC address included in the information of the decrypted job execution ticket, which is plaintext, corresponds to the MAC address of its own printer 100, and that the ticket issue destination MAC address corresponds to the printing requester MAC address.

In addition to this, when a term of validity is set for the job execution ticket, it is verified whether the elapsed time from the time of issue of the job execution ticket to the current time is within the set term of validity. If the elapsed time exceeds the term of validity, the printer 100 terminates the processing without carrying out printing process.

The printing system may be configured such that the printing job at this time is discarded, and a printing rejection notification is sent to the print server 200, which is the printing requester, and also may be configured such that the printing job is stored (accumulated) to be transferred to another printer.

In addition, the printer 100 can manage the issue destination of the job execution ticket for verifying whether the job execution ticket embedded in the printing job is sent from the issue destination under management. By the way, when the checking code is provided for the job execution ticket, it is verified whether such an unfairness as falsification, or the like, is not made, and then the checking code is removed for carrying out the above-described verification processing.

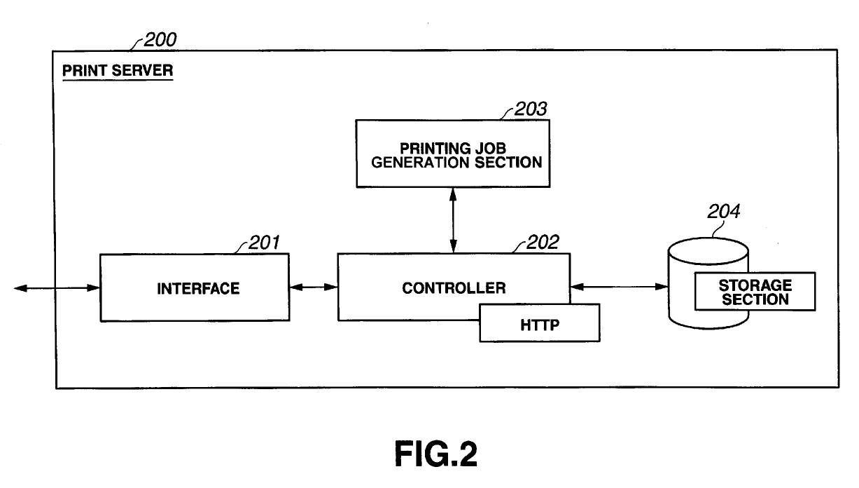

FIG. 2 gives one example of block diagram illustrating the detailed configuration of the print server included in the printing system as shown in FIG. 1.

The print server 200 as shown in FIG. 2 includes an interface 201, a controller 202, a printing job generation section 203, and a storage section 204, and functions as an HTTP (Hyper Text Transfer Protocol) client and an HTTP server.

When the printing data for which printing is requested by the client PC 300 is received by the controller 202 via the interface 201, the printing data is temporarily stored in the storage section 204. Then, the print server 200 generates the printing execution verification notification showing a request for printing out the printing data requested by the client PC 300 to print out. In that printing execution verification notification, the MAC address for identifying the print server 200 that requests to print out is embedded. And, through the interface 201, that printing execution verification notification is sent to the printer 100.

Additionally, upon receiving a job execution ticket sent back by the printer 100 in response to the sent printing execution verification notification, the printing data to be requested for printing out is retrieved from the storage section 204, and the printing job generation section 203 is requested to generate a printing job using the printing data as well as the job execution ticket.

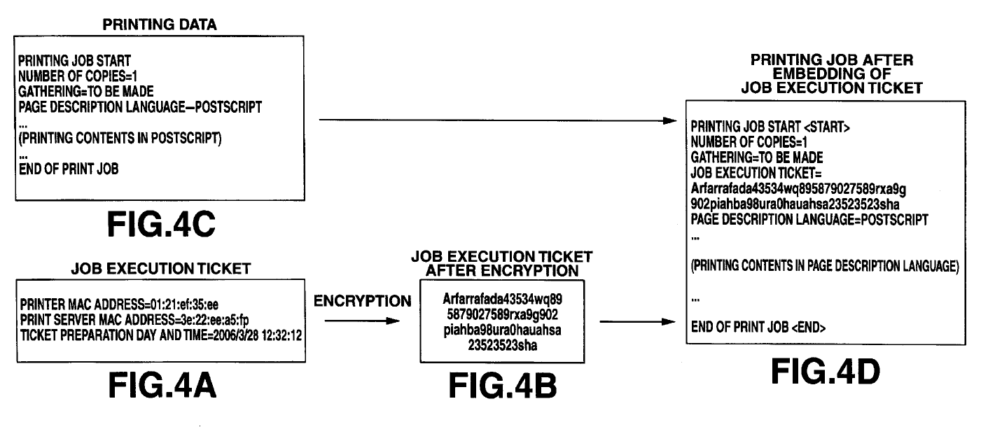

Upon receiving the request, the printing job generation section 203 generates the printing job described in PDL (Page Description Language), and embeds the job execution ticket. This job execution ticket is encrypted, and is embedded in the encrypted state. As one example of this embedding processing, there provided a method that sets to the printing job the control command of “job execution ticket=” for assigning the job execution ticket. FIG. 4A to FIG. 4D show an example of embedding the job execution ticket in the printing job using the control command.

And, upon receiving the printing job generated by the printing job generation section 203, the controller 202 transfers the printing job to the printer 100 for carrying out printing request.

FIG. 4A to FIG. 4D are drawings illustrating one example of the printing job generated by the printing job generation section of the print server as shown in FIG. 2.

FIG. 4A shows one example of the job execution ticket generated by the printer 100 that receives the printing execution verification notification from the print server 200, and FIG. 4B shows one example of encrypted job execution ticket. Additionally, FIG. 4C shows one example of the printing data described in PDL for which printing is requested by the client PC 300.

And, FIG. 4D shows one example of the printing job in a state where the encrypted job execution ticket as shown in FIG. 4B is embedded, by the print server 200, in the printing data as shown in FIG. 4C.

FIG. 4D gives an example in which the encrypted job execution ticket is embedded in the header portion that gives the printing condition and the printing setting, and the job execution ticket is assigned with the job execution ticket assigning command. In the example as given in FIG. 4D, the job execution ticket assigning command of “job execution ticket=” is used for assignment.

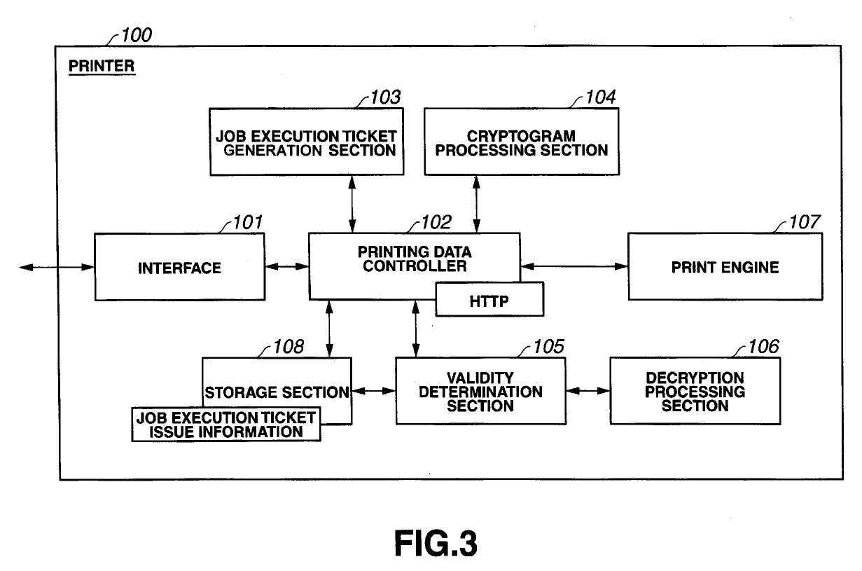

FIG. 3 gives one example of block diagram illustrating the detailed configuration of the printer constituting the printing system as shown in FIG. 1.

The printer 100 as shown in FIG. 3 includes an interface 101, a printing data controller 102, a job execution ticket generation section 103, a cryptogram processing section 104, a validity determination section 105, a decryption processing section 106, a print engine 107, and a storage section 108, and functions as an HTTP client and an HTTP server.

First, when a printing request is received through the interface 101 from a node (the print server 200 or the client PC 300) connected through the communication line, the printing data controller 102 temporarily stores in the storage section 108 the printing data for the received printing request, and determines whether the job execution ticket is embedded in the printing data.

This printing data controller 102 carries out the determination process whether the job execution ticket is embedded or not, by judging whether the job execution ticket assigning command assigned by the printing job generation section 203 in the print server 200 as shown in FIG. 2 is set in the printing data, and whether the job execution ticket is assigned in this job execution ticket assigning command.

When it is determined that the job execution ticket assigning command is not set, or the job execution ticket is not assigned in the job execution ticket assigning command, resulting in the job execution ticket being not embedded, the printing requester cannot be identified. Thus, a printing rejection response showing that printing cannot be carried out is transferred to the node as the printing requester. The node as the printing requester that receives this printing rejection response generates a printing execution verification notification in order to verify whether it is possible to carry out printing out, and sends it to the printer 100.

On the other hand, when the job execution ticket is assigned in the job execution ticket assigning command, resulting in the job execution ticket being embedded, the validity determination section 105 is requested to determine whether that job execution ticket is valid.

Upon receiving the request, the validity determination section 105 requests the decryption processing section 106 to carry out the decryption processing of the encrypted job execution ticket, and determines whether the job execution ticket decrypted into plaintext by the decryption processing section 106 is valid. This validity determination section 105 compares the ticket issuer MAC address included in the job execution ticket with the MAC address set for its own printer 100 that is stored in the storage section 108, for determining whether they are identical to each other, and further, compares the ticket issue destination MAC address included in the same job execution ticket with the printing requester MAC address in the printing data, for determining whether they are identical to each other.

When the addresses in the respective sets of addresses are identical to each other, it is determined that the job execution ticket is valid.

Further, this validity determination section 105 may verify whether, in the information on the issue destination of the job execution ticket that is stored in the storage section 108, the MAC address of the requester for the printing data including the job execution ticket that validity is verified is entered.

When the validity of the job execution ticket is verified by the validity determination section 105, the print engine 107 carries out the printing out processing of the printing job in which the pertinent job execution ticket is embedded.

Note that the printing system may be configured such that, when the validity of the job execution ticket is not verified by the validity determination section 105, that printing data is temporarily stored (accumulated) in the storage section 108, and with the authentication information that authenticates the operator who carries out the printing request being received from the client PC 300 or the print server 200, is transferred to another printer (not shown) on the network.

The printing system may be also configured such that, when the validity of the job execution ticket is not verified, a notification is performed. For example, if the job execution ticket is not verified because the ticket issuer MAC address included in the job execution ticket is not identical to the MAC address set for its own printer 100, the notification may indicate that the MAC addresses are not identical to each other.

In this case, the authentication information is generated by the authentication apparatus (not shown), the print server, or the like, showing that the operator who carries out the printing request is authenticated. Needless to say, the printing system may be configured such that the printer communicates with the authentication apparatus for receiving the authentication information from the authentication apparatus.

Next, when a printing execution verification notification is sent from a node connected by the communication line through the interface 101, the printing data controller 102 reads the sender MAC address included in that printing execution verification notification, and requests the job execution ticket generation section 103 to generate the job execution ticket using the sender MAC address together with the MAC address of its own printer 100 stored in the storage section 108.

At this time, when list information about the print servers from which printing request can be received, list information about the print servers for which reception of printing request is to be rejected, or the like, is stored in the storage section 108, the sender of the printing execution verification notification is compared with that list in order to verify whether it is a requester for which the job execution ticket can be issued, before the job execution ticket generation section 103 is requested to generate the job execution ticket.

The job execution ticket generation section 103 that is requested by the printing data controller 102 to generate the job execution ticket generates the job execution ticket including the MAC address of the print server 200 as the ticket issue destination that is received, the MAC address of the printer 100 as the ticket issuer, and the current time (the current day and time).

Then, the printing data controller 102 requests the cryptogram processing section 104 to carry out encryption for the job execution ticket generated by the job execution ticket generation section 103. The cryptogram processing section 104 that receives the request encrypts the job execution ticket by the encryption algorithm.

The job execution ticket that is encrypted by the cryptogram processing section 104 is transferred to the print server 200 as the issue requester by the printing data controller 102 through the interface 101.

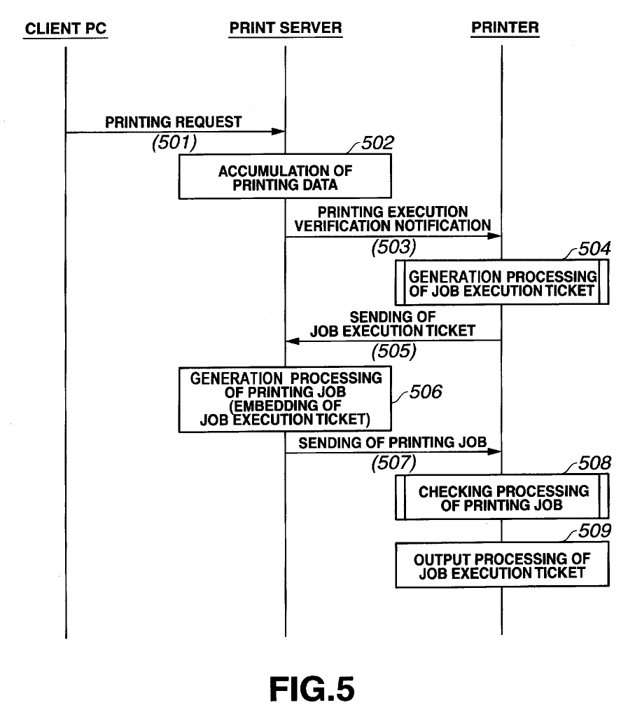

FIG. 5 shows a sequence diagram illustrating the status transition of the printing system pertaining to the exemplary embodiment of the present invention.

In FIG. 5, when the client PC carries out printing request to the print server (501), the print server temporarily accumulates the printing job for which printing is requested (502). This is the status in which it is being waited that a printing permission is given by the printer that carries out printing out. Then, in order to obtain the printing permission, the print server sends a printing execution verification notification to the printer (503).

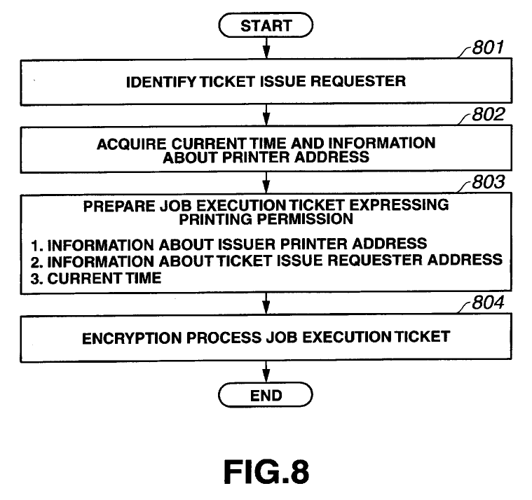

The printer that receives the printing execution verification notification from the print server generates the job execution ticket using the MAC address of the print server as the sender of the printing execution verification notification, the MAC address of its own printer, and the current time (504). The printer sends the generated job execution ticket as a reply to the print server as the sender of the printing execution verification notification (505). The print server embeds the issued job execution ticket in the printing data, and generates the printing job for which printing is to be requested (506). FIG. 8 shows a detailed flowchart illustrating the generation processing of the job execution ticket that is carried out by the printer at this time.

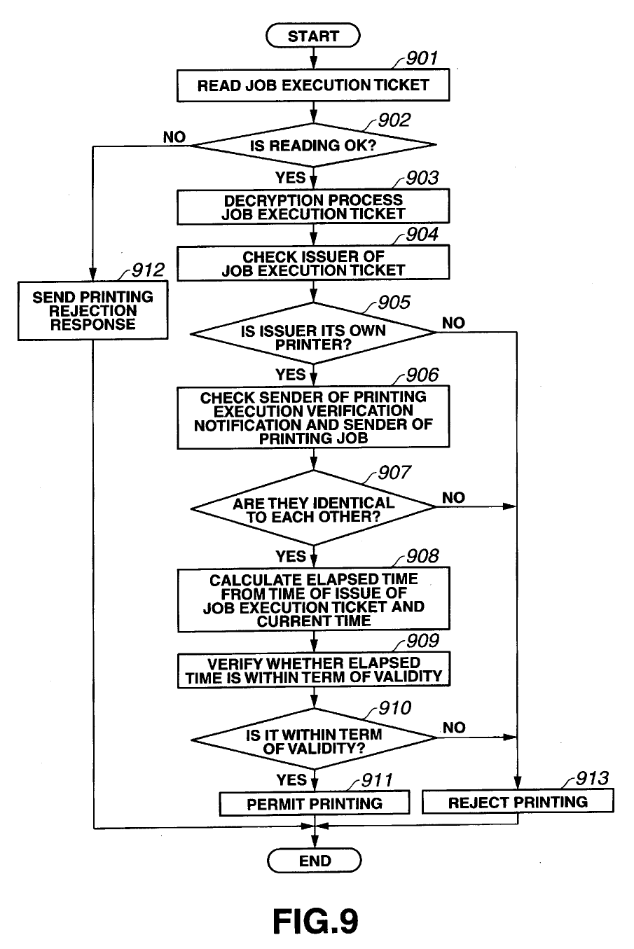

The print server sends the generated printing job to the printer (507), and the printer that receives it reads out the job execution ticket embedded in the printing job to check it (508). FIG. 9 shows a detailed flowchart illustrating the checking processing of the job execution ticket at this time.

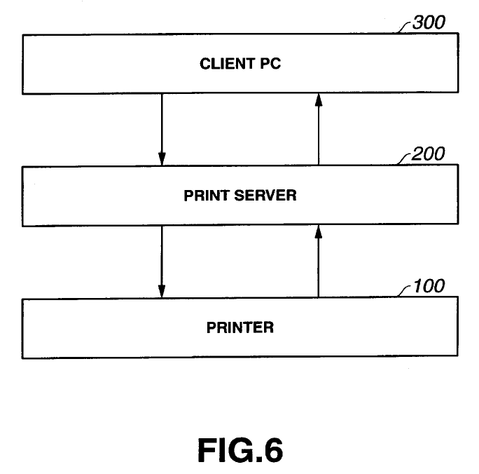

As a result of reading out the job execution ticket for checking, when it is determined that the received printing job can be printed out, printing out is carried out (509). In other words, printing out is carried out with a logical structure as shown in FIG. 6.

All the printing requests are made via the print server 200 without the printing job being directly sent from the client PC 300 to the printer 100.

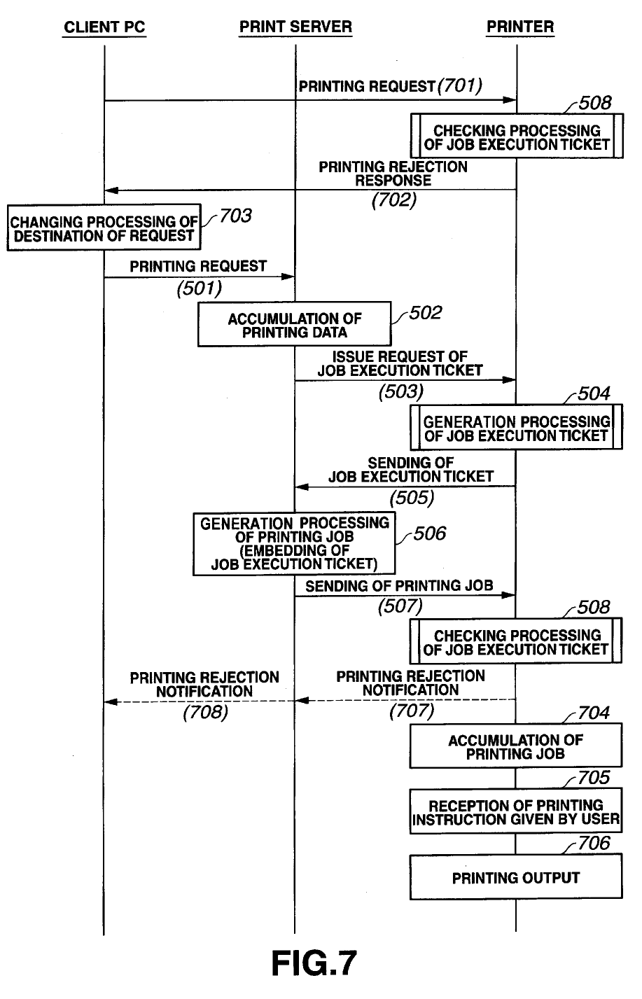

FIG. 7 shows one example of sequence diagram illustrating the status transition of the printing system to which the printing program pertaining to the exemplary embodiment of the present invention is applied.

FIG. 7 illustrates the sequence in a case when printing request is carried out directly to the printer from the client PC. When printing request is carried out to the printer from the client PC (701), checking processing of the job execution ticket is carried out on the printing job for which printing is requested (508). FIG. 8 illustrates the detail of this checking processing, and in this case, because no job execution ticket is embedded in the printing job, the printer sends a printing rejection response to the client PC (702).

And, the client PC carries out processing of changing the destination of the printing request into the print server (703), carrying out printing request to the print server (501).

Thereafter, the print server temporarily accumulates the printing job for which printing is requested (502), and in order to obtain the printing permission, the print server sends a printing execution verification notification to the printer (503).

The printer that receives the printing execution verification notification from the print server generate the job execution ticket using the MAC address of the print server as the sender of the printing execution verification notification, the MAC address of its own printer, and the current time (504). The printer sends the generated job execution ticket as a reply to the print server as the sender of the printing execution verification notification (505). The print server embeds the issued job execution ticket in the printing data, and generates the printing job for which printing is to be requested (506).

The print server sends the generated printing job to the printer (507), and the printer that receives it reads out the job execution ticket embedded in the printing job to check it (508).

By this checking processing, when it is determined that printing out cannot be carried out, a printing rejection notification is sent to the client PC through the print server (707, 708).

In addition, this sequence as illustrated in FIG. 7 is a sequence for a printer having the on-demand function in which printing out is implemented by the user operating the operation panel of the printer, and in this case, the printing job for which it is determined, by the checking processing of the job execution ticket (508), that printing is possible is temporarily accumulated (704) and the printer waits until a printing instruction is given by the user.

The user operates the operation panel provided in the printer for giving a printing instruction (705), whereby printing out for the accumulated printing job is carried out (706).

Note that the above-described sequence is configured such that, when a printing job in which the job execution ticket is not embedded is received, a printing rejection response is sent, and when it is determined, by the checking processing of the job execution ticket, that the ticket is invalid, a printing rejection response is sent. However, in these cases, a mail may be sent to the previously assigned manager.

Further, the printing system may be configured such that, when the user operates the operation panel to instruct to print out, the authentication screen for the user ID and password is displayed for authenticating the user, and only when authentication is carried out, printing out is allowed to be carried out.

FIG. 8 shows a detailed flowchart illustrating the flow of generation processing of the job execution ticket.

In FIG. 8, upon receiving a printing execution verification notification, the printer identifies the sender of the printing execution verification notification (801), and acquires the current time and the MAC address of its own printer, which are information for generating the job execution ticket (802).

The printer generates a job execution ticket including the MAC address of the identified sender of the printing execution verification notification, and the current time and the acquired MAC address of the printer (803). The generated job execution ticket is encrypted by the encryption algorithm (804).

FIG. 9 shows one example of detailed flowchart illustrating the flow of checking processing of the job execution ticket.

In FIG. 9, the printer that receives a printing job carries out the reading processing of the job execution ticket from the printing job (901). It is determined whether, by the reading processing, the job execution ticket is read (902), and when it is determined that the job execution ticket is not read (NO at 902), a printing rejection response is sent to the requester for the printing job (912).

In addition, when it is determined that the job execution ticket is read from the printing job (YES at 902), this job execution ticket is decrypted (903), and from the job execution ticket that is changed into plaintext, the information about the issuer of the ticket is checked (904). In other words, whether the issuer is its own printer is checked.

As a result of the check, it is determined whether the issuer of the ticket is its own printer (905), and when the issuer of the ticket is its own printer (YES at 905), it is checked whether the sender of the printing execution verification notification and the sender of the printing job are identical to each other (906).

From the checking result, whether they are identical to each other is determined (907), and when it is determined that they are identical (YES at 907), then from the time of issue of the job execution ticket and the current time, the elapsed time is calculated (908). Whether the calculated elapsed time is within the term of validity is verified (909). From the result of the verification, it is determined whether the elapsed time is within the term of validity (910), and when the elapsed time is within the term of validity (YES at 910), printing out for the printing job for which printing is requested is permitted (911).

On the other hand, when the issuer of the job execution ticket is not its own printer (NO at 905), or, when the sender of the printing execution verification notification and the sender of the printing job are not identical to each other (NO at 907), or, when the elapsed time is not within the term of validity (NO at 910), the printing out is rejected (913).

### SECOND EXAMPLE

In First Example as described above, as a method for assigning the job execution ticket, the method that uses the job execution ticket assigning command for assigning it to the printing job is described. However, in the present Second Example, the method that, for assignment, connects the job execution ticket to the printing job for which printing out is to be carried out will be described.

The system configuration in the present Second Example is the same as that as shown in FIG. 1, FIG. 2, and FIG. 3, which are used in the description of First Example, except for some points that will be described below.

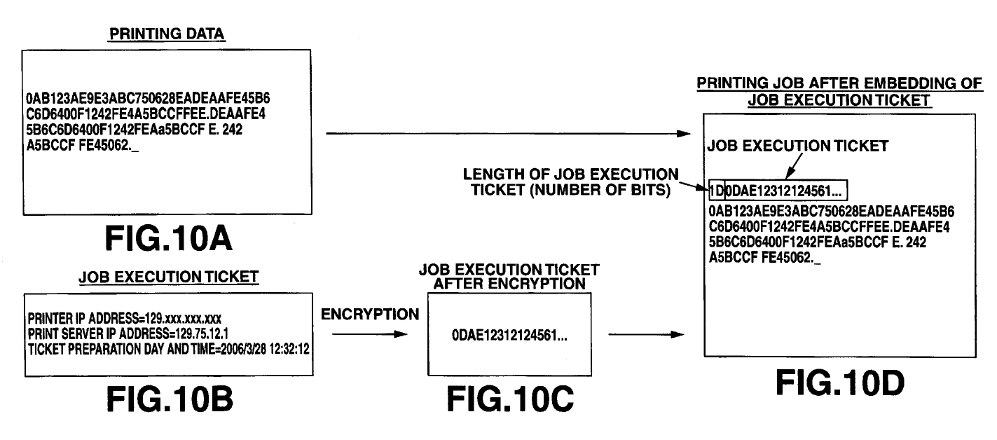

FIG. 10A to FIG. 10D illustrate how the job execution ticket in the present Second Example is assigned to the printing job.

FIG. 10A shows the printing data generated by the client PC that is expressed by the hexadecimal notation; FIG. 10B shows the job execution ticket as plaintext; and FIG. 10C shows the job execution ticket that is the job execution ticket as shown in FIG. 10B that is encrypted by the prescribed encryption algorithm to be expressed by the hexadecimal notation.

In addition, FIG. 10D shows the printing job as a result of connecting the printing data as shown in FIG. 10A to the job execution ticket as shown in FIG. 10C.

The printing job as shown in FIG. 10D is made up of “information showing the length of the job execution ticket”, the “job execution ticket”, and the “printing data”. With this printing job, the head two bits provide information that expresses the length of the job execution ticket; the bit string that, beginning at the third bit, is given over the length of the job execution ticket that is expresses by the head two bits provides the job execution ticket; and the job execution ticket is followed by the printing data.

As the “information showing the length of the job execution ticket” in the printing job as shown in FIG. 10D, “10” is given at the first and second bits, which express that the job execution ticket is of 10 bytes (equal to 80 bits).

In other words, the 80 bits ranging from the third bit to the eighty second bit in the printing job provide the job execution ticket, and the bits starting from the eighty third bit provide the printing data.

In FIG. 10D, the head two bits give the information showing the length of the job execution ticket, however, the previously assigned number of bits may be set as the information showing the length of the job execution ticket.

The printing job in which the job execution ticket is thus given is sent from the print server to the printer, then, the printer takes out the assigned job execution ticket for carrying out the processing as explained with reference to the sequence diagrams as shown in FIG. 5 and FIG. 7.

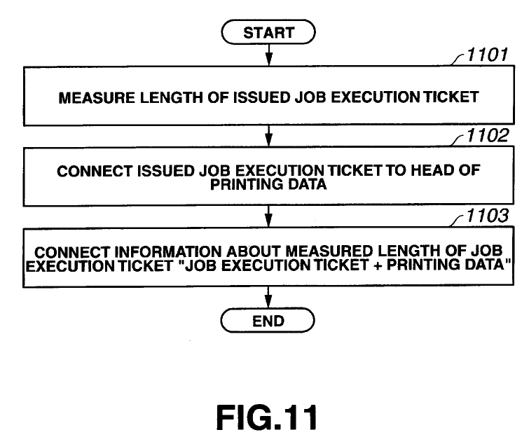

FIG. 11 is one example of flowchart illustrating the flow of the processing of generating the printing job in the print server.

The flow of processing as shown in FIG. 11 is a modification of the generation processing of the printing job as shown in the sequence diagrams in FIG. 5 and FIG. 7 (the embedding of the job execution ticket) (506), and when the printer is requested to issue a job execution ticket, and the job execution ticket is issued from the printer, the processing is started.

First, the length of the issued job execution ticket is measured (1101). Next, to the head of the printing data for which printing is to be requested, the issued job execution ticket is connected (1102). By this processing, the status of “job execution ticket+printing data” is produced.

Then, the information about the measured length of the job execution ticket is connected to the head of the “job execution ticket+printing data” (1103). By this processing, the printing job in the status of “length of job execution ticket+job execution ticket+printing data” is generated.

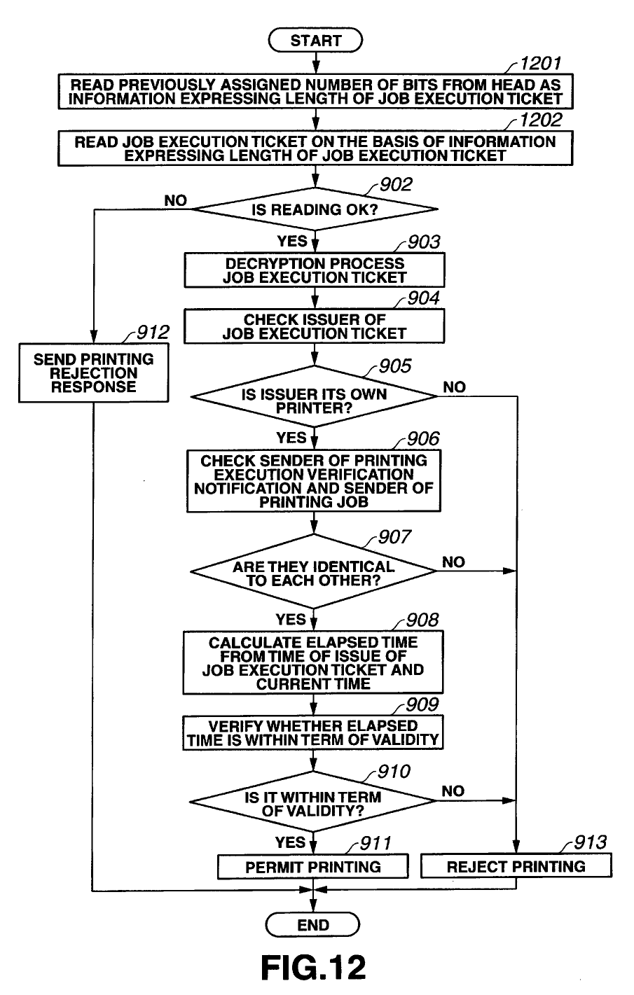

FIG. 12 is one example of flowchart illustrating the flow of checking processing of the job execution ticket in the printer.

This flowchart as shown in FIG. 12 is similar to the flowchart as shown in FIG. 9, and when the printing job is received, the processing is started.

First, the previously assigned number of bits from the head is read as the information showing the length of the job execution ticket (1201). Then, the bit string that, beginning at the bit following the information showing the length of the job execution ticket that is read, is given over that length is read as the job execution ticket (1202).

And, it is determined whether, by these reading processings, the job execution ticket is normally read (902). The subsequent flow is identical to the flow of processing as shown in FIG. 9.

### THIRD EXAMPLE

In the present Third Example, the printing data and the job execution ticket are separately sent. Also in Third Example, the system configuration is that as illustrated in FIG. 1, FIG. 2, and FIG. 3, as is the case with Second Example.

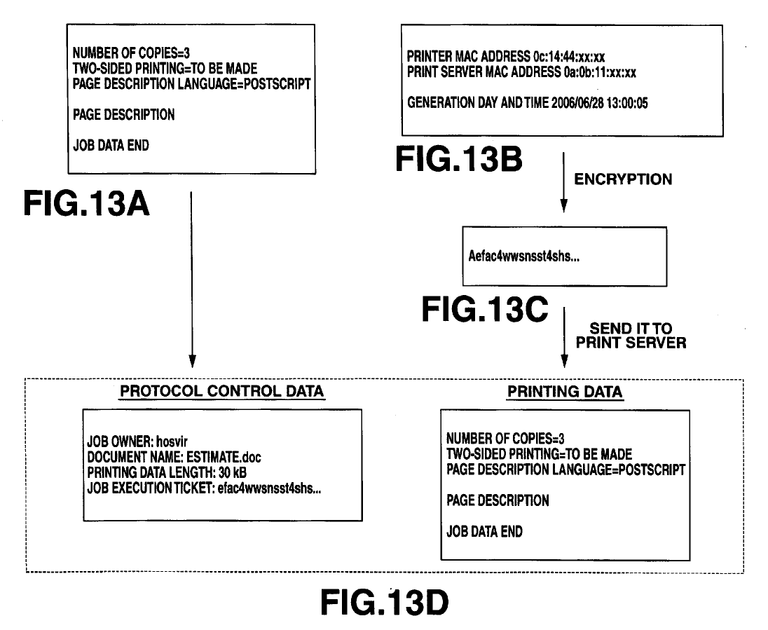

FIG. 13A to FIG. 13D are conceptual drawings illustrating the outline of the present Third Example.

FIG. 13A shows the printing data generated by the client PC; FIG. 13B shows the job execution ticket generated by the printer; and FIG. 13C shows the job execution ticket generated by encrypting the job execution ticket as shown in FIG. 13B by a prescribed encryption algorithm.

FIG. 13D shows the data for which printing is to be requested of the printer, and which is made up of the protocol control data and the printing data.

The protocol control data is attribute data that is to be sent from the print server to the printer on the basis of the communication protocol for communication between the print server and the printer, having a configuration in which a job execution ticket attribute is provided, and a job execution ticket is assigned as the attribute value thereof.

In addition, the printing data is the printing data itself that is generated by the client PC.

These protocol control data and printing data are generated by the print server to be sent to the printer.

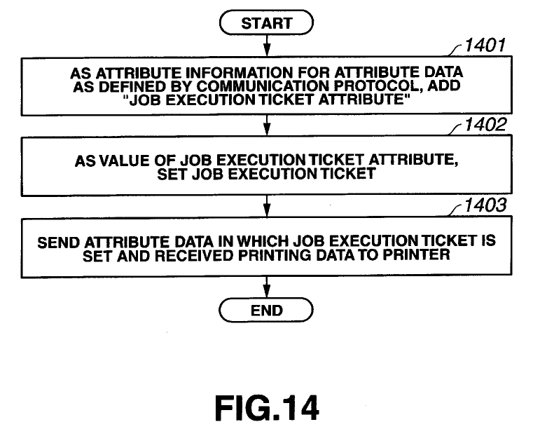

FIG. 14 is one example of flowchart illustrating the flow of the processing of generating the printing job in the print server.

In FIG. 14, when the printing request for the printing data generated by the client PC is received, and the job execution ticket is received from the printer, the processing is started.

To the attribute data as defined by the communication protocol to be used for communication between the print server and the printer that carries out printing out, the job execution ticket attribute is added (1401). Then, as the value of the job execution ticket attribute that is added, the job execution ticket is set (1402).

And, the attribute data for which the job execution ticket is set and the printing data for which printing is to be requested are sent to the printer (1403).

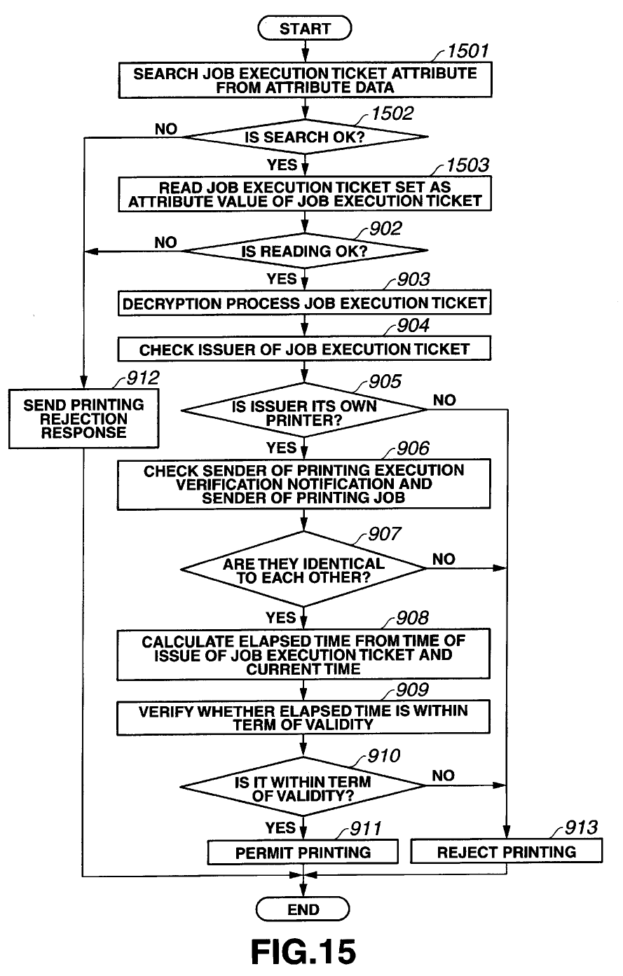

FIG. 15 is one example of flowchart illustrating the flow of checking processing of the job execution ticket in the printer.

The flowchart as shown in FIG. 15 is similar to that as shown in FIG. 9 and FIG. 12, thus the different points will be mainly described.

In FIG. 15, when the printing job including the attribute data and the printing data is received from the print server, the processing is started, and it is searched whether the job execution ticket attribute is set in the attribute data received (1501). As a result of the search, it is determined whether the search is made (1502), and when the search is not made (NO at 1502), a printing rejection response is sent to the print server as the requester (912).

On the other hand, when the search is made (YES at 1502), the job execution ticket as the attribute value that is set for the job execution ticket attribute is read (1503).

Then, the determination processing about whether the reading is made is carried out, which is followed by the processing that is identical to that as shown in FIG. 9.

With the present invention, a printing system having the above-stated communication function can also be caused to implement the above-stated operations, or from a storage medium (such as a CD-ROM, DVD-ROM, or the like) that stores a program for causing the above-stated means to be configured, the program can be installed in the computer for causing it to be implemented to configure a printing system that implements the above-stated processing. The computer constituting the printing system is connected to the CPU (Central Processor Unit), the ROM (Read Only Memory), the RAM (Random Access Memory), and the hard disk through the system bus. The CPU uses the RAM as the working area for carrying out the processing in accordance with the program stored in the ROM or the hard disk.

In addition, the medium for supplying the program may be a communication medium (a medium that temporarily or fluidly holds the program like a communication line, or a communication system). For example, the program may be given on the electronic bulletin board (BBS: Bulletin Board Service) on the communication network to be distributed through the communication line.

The present invention is not limited to Examples as described above and as illustrated in the drawings, and can be modified as appropriate for implementation without departing in any way from the scope and spirit thereof.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A computer readable recording medium storing a printing program for causing a computer included in a printing apparatus having a printing out section to execute a process, the process comprising:
storing apparatus information about the printing apparatus;
generating a job execution ticket including the stored apparatus information on receiving a printing request from an external apparatus;
sending the generated job execution ticket to the external apparatus;
receiving from the external apparatus printing job in which a job execution ticket is embedded;
determining whether apparatus information about printing apparatus included in the job execution ticket embedded in the received printing job is identical to the stored apparatus information; and
sending to the printing out section, when the apparatus information are determined to be identical, the printing job in which the job execution ticket is embedded.

2. The computer readable recording medium storing the printing program of claim 1, the process further comprising:
generating a job execution ticket further including information about the external apparatus; and
further determining whether information about an external apparatus included in the job execution ticket embedded in the received printing job indicates the external apparatus from which the printing job is received.

3. The computer readable recording medium storing the printing program of claim 1, the process further comprising
controlling, when the apparatus information are not determined to be identical, the received printing job not to be performed.

4. The computer readable recording medium storing the printing program of claim 2, the process further comprising
controlling, when the apparatus information are not determined to be identical or the information about the external apparatus included in the job execution ticket does not determined to indicate the external apparatus from which the printing job is received, the received printing job not to be performed.

5. The computer readable recording medium storing the printing program of claim 1, the process further comprising
notifying, when the apparatus information are not determined to be identical, the apparatus information.

6. The computer readable recording medium storing the printing program of claim 3, the process further comprising
notifying, when the apparatus information are not determined to be identical, the apparatus information.

7. The computer readable recording medium storing the printing program of claim 2, the process further comprising:
accumulating, when the apparatus information are not determined to be identical or the information about the external apparatus included in the job execution ticket does not determined to indicate the external apparatus from which the printing job is received, the printing job in which the job execution ticket is embedded;
carrying out authentication by receiving authentication information from the external apparatus; and
transferring, based on a result of the authentication, the accumulated printing data to another printing apparatus that is previously assigned.

8. The computer readable recording medium storing the printing program of claim 1, the process further comprising:
setting a term of validity for the job execution ticket;
determining whether the job execution ticket embedded in the printing job received from the external apparatus is within the set term of validity.

9. The computer readable recording medium storing the printing program of claim 2, the process further comprising:
setting a term of validity for the job execution ticket;
determining whether the job execution ticket embedded in the printing job received from the external apparatus is within the set term of validity.

10. The computer readable recording medium storing the printing program of claim 3, the process further comprising:
setting a term of validity for the job execution ticket;
determining whether the job execution ticket embedded in the printing job received from the external apparatus is within the set term of validity.

11. The computer readable recording medium storing the printing program of claim 4, the process further comprising:
setting a term of validity for the job execution ticket;
determining whether the job execution ticket embedded in the printing job received from the external apparatus is within the set term of validity.

12. The computer readable recording medium storing the printing program of claim 5, the process further comprising:
setting a term of validity for the job execution ticket;
determining whether the job execution ticket embedded in the printing data received from the external apparatus is within the set term of validity.

13. The computer readable recording medium storing the printing program of claim 6, the process further comprising:
setting a term of validity for the job execution ticket;
determining whether the job execution ticket embedded in the printing job received from the external apparatus is within the set term of validity.

14. The computer readable recording medium storing the printing program of claim 7, the process further comprising:
setting a term of validity for the job execution ticket;
determining whether the job execution ticket embedded in the printing job received from the external apparatus is within the set term of validity.

15. A printing apparatus, comprising:
a storage section that stores apparatus information for identifying the printing apparatus;
a ticket generation section that, on receiving a printing request from an external apparatus, generates a job execution ticket including the stored apparatus information;
a transmission section that sends the job execution ticket generated by the ticket generation section to the external apparatus;
a reception section that receives, from the external apparatus, printing job in which a job execution ticket is embedded;
a determination section that determines whether apparatus information about a printing apparatus included in the job execution ticket embedded in the printing job received in the reception section is identical to the stored apparatus information; and
a printing section that, when the apparatus information are determined to be identical by the determination section, performs the printing job received in the reception section.

16. The printing apparatus of claim 15, wherein
when the apparatus information are not determined to be identical, the printing section controls the printing job received in the reception section not to be performed.

17. The printing apparatus of claim 15, wherein:
the ticket generation section further includes information about the external apparatus in the job execution ticket; and
the determination section further determines whether information about an external apparatus included in the job execution ticket embedded in the received printing job indicates the external apparatus from which the printing job is received.

18. A printing method, comprising:
storing apparatus information about a printing apparatus;
generating a job execution ticket including the stored apparatus information on receiving a printing request from an external apparatus;
sending the generated job execution ticket to the external apparatus;
receiving from the external apparatus printing job in which a job execution ticket is embedded;
determining whether apparatus information about printing apparatus included in the job execution ticket embedded in the received printing job is identical to the stored apparatus information; and
sending, when the apparatus information are determined to be identical, the printing job in which the job execution ticket is embedded.

19. A computer data signal embodied in a carrier wave for enabling a computer to perform a process for printing, the process comprising:
storing apparatus information about a printing apparatus;
generating a job execution ticket including the stored apparatus information on receiving a printing request from an external apparatus;
sending the generated job execution ticket to the external apparatus;
receiving from the external apparatus printing job in which a job execution ticket is embedded;
determining whether apparatus information about printing apparatus included in the job execution ticket embedded in the received printing job is identical to the stored apparatus information; and
sending, when the apparatus information are determined to be identical, the printing job in which the job execution ticket is embedded.
